(19) United States
(12) Patent Application Publication
(10) Pub. No.: US 2005/0273493 A1
(43) Pub. Date: Dec. 8, 2005

(54) Proximity reminder system using instant messaging and presence

(76) Inventors: John Buford, Lawrenceville, NJ (US); Mahfuzur Rahman, South Brunswick, NJ (US)

Correspondence Address: HARNESS, DICKEY & PIERCE, P.L.C., P.O. BOX 828, BLOOMFIELD HILLS, MI, 48303, US

(21) Appl. No.: 10/862,162

(22) Filed: Jun. 4, 2004

(51) Int. Cl. H04M 1/64; H04M 11/00

(52) U.S. Cl. 709/204; 379/88.13

(57) ABSTRACT

Electronic reminders are created and managed using instant messages and/or multimedia messages. Reminders can be associated with future location or proximity events. Proximity data provides qualitative information about the user's location and this qualitative information may be used to provide reminders through the instant messaging infrastructure.

### BACKGROUND OF THE INVENTION

The present invention relates generally to instant messaging and presence systems. More particularly, the invention relates to a reminder system that employs proximity information to enhance the usefulness of the reminders.

Instant messaging systems currently support publishing a presence attribute that tells the instant messaging activity state of the user. The user's buddies can access the presence attribute to determine whether the user is currently online, or not. Although not supported by all instant messaging applications, the instant messaging and presence standards also support the inclusion of geographic information system (GIS) data as part of the presence attribute. The GIS data gives an xyz coordinate representing the user's current location.

### SUMMARY OF THE INVENTION

The present invention extends the instant messaging paradigm to a proximity reminder system and proximity information system. Using the system, electronic reminders can be created and managed using instant messages and/or multimedia messages. The proximity reminder system mediates and stores proximity attributes in association with the instant messaging and presence attributes. Proximity information is distinguished from position information (e.g., GIS data) in that the proximity information represents higher level proximity associations that may or may not be based on GIS data.

For example, two persons may be deemed in close proximity to one another either because they have proximate GIS coordinates or because within a certain time frame they both passed through a secure doorway (e.g., by using a keycard to enter a secure office building). Proximity information, therefore, represents a qualitative measure that the user is near or in the vicinity of something else (e.g., another person, a particular building, traveling on a particular roadway, at a shopping mall or airport, and the like).

The proximity reminder system using instant messaging and presence (IMP) protocols has a number of advantages. These include:
Many types of mobile devices, as well as computers, are equipped with instant messaging clients;
Users are sending and receiving instant messages for other notifications. It is therefore convenient for the user to have a single messaging environment;
Attributes such as location and availability, which are utilized for proximity reminders, can be represented in the presence attributes of the IMP system;
The publishing of presence attributes to other users and applications (e.g., a reminder management system) can be controlled by the user. IMP users can protect their privacy this way;
A user can publish his or her presence attributes (including proximity) to multiple devices. Based on the proximity of the user, reminders and event notifications can be generated by the device when changes to the presence attributes occur. This allows having a distributed environment by distributing subscriptions of reminder notifications to multiple devices;
The inherent security mechanisms of instant messaging and presence protocols can be used to provide a secure mobile environment for the reminder system, rather than having to implement a separate security mechanism; and
The resulting system does not require application software to be dynamically downloaded to the device, as it works through the existing instant messaging and presence.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention. Accordingly for a more complete understanding of the invention, its objects and advantages, refer to the remaining specification and to the accompanying drawings.

### BRIEF DESCRIPTION OF THE DRAWINGS

The present invention will become more fully understood from the detailed description and the accompanying drawings, wherein:

FIG. 1 is an architecture system diagram of a proximity reminder system using instant messaging and presence;

FIG. 2 illustrates the reminder management system useful in conjunction with the instant messaging and presence (IMP)-based reminder system.

### DETAILED DESCRIPTION OF THE PREFERRED EMBODIMENTS

The following description of the preferred embodiment(s) is merely exemplary in nature and is in no way intended to limit the invention, its application, or uses.

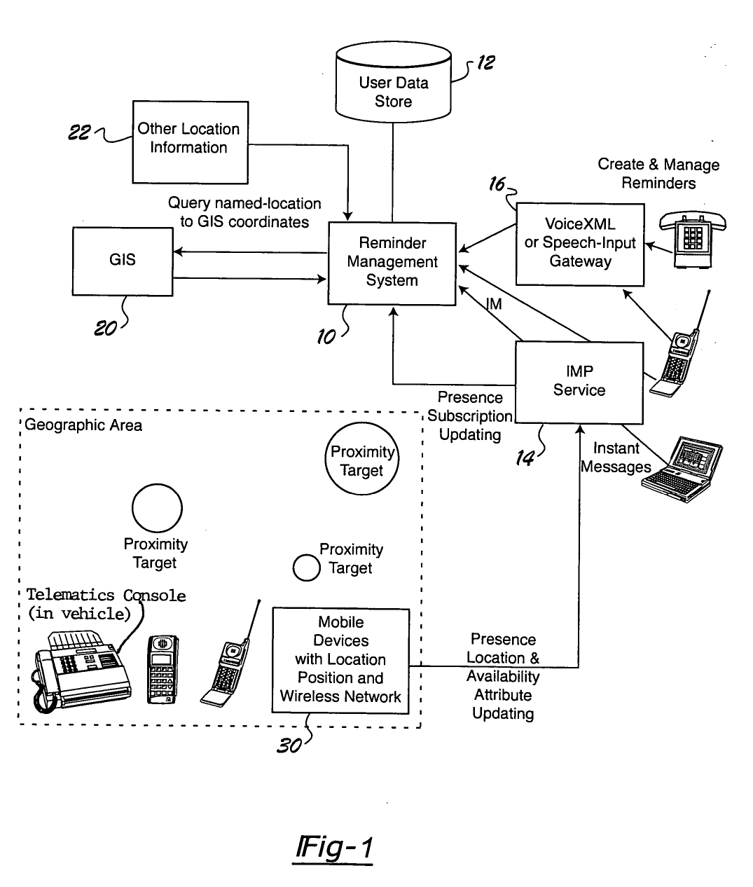

Referring to FIG. 1, the proximity reminder system employs a reminder management system 10 that may have an associated user data store 12. The reminder management system is configured to communicate using instant messaging and presence protocols and is thus capable of communicating with an instant messaging and presence (IMP) service 14. In one embodiment, the reminder management system is also capable of handling speech information. The system includes a speech recognizer and syntactic parser that allows the reminder management system to receive and interpret speech messages such as messages sent through a voice XML or speech input gateway 16.

The reminder management system 10 may be configured to receive position and proximity information from a variety of sources, including from a geographic information system (GIS) 20 as well as from other location information sources 22. The GIS system provides xyz position data. To convert such information into proximity information, the reminder management system 10 may have a named-location-to-GIS-coordinates database stored within the user data store 12. Alternatively, the reminder management system may acquire information that converts GIS coordinates into named locations by accessing a remote data store, such as a data store located on the internet.

Other sources of location information 22 can be quite diverse. One class of such information relies upon event information from which location information is deduced. For example, the user passes through a secure checkpoint (such as a traffic turnstile or keycard entry gate) and proximity information is derived from this event. (At time 0:00 the person was at checkpoint A traveling at 60 miles per hour; 30 minutes later the person thirty miles east of checkpoint A, for example.)

Proximity information can also be extracted from actions the user is performing (interacting with an ATM machine or using a credit card to make a purchase at the store).

In addition, proximity information can be obtained directly vis-à-vis another user, when the respective user's instant messaging and presence systems automatically detect one another. In this regard, the user's mobile device, illustrated at 30, may be configured to support location and position information and send that information over a suitable wireless network. In this way, the respective devices of two users may discover one another and exchange pertinent proximity information.

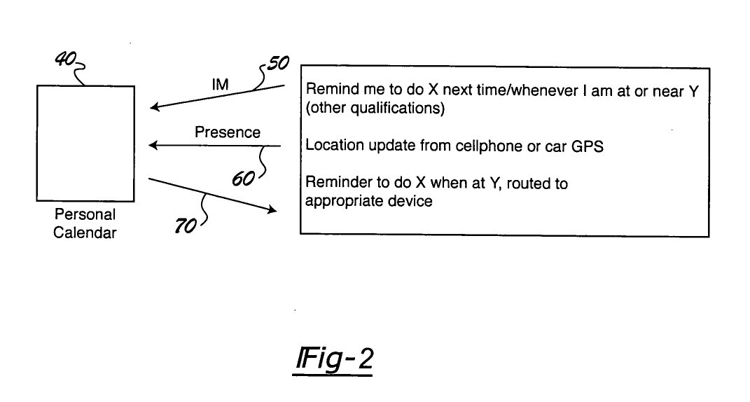

As illustrated in FIG. 2, the reminder management system 10 can be used to implement a personal calendar 40. The calendar can be an application resident on the user's mobile device, or resident on some other system. The user interacts with the calendar using instant messages. As illustrated, the user may send a first instant message “remind me to do x the next time/whenever I am at or near Y (other qualifications).” This instant message is sent to the personal calendar as at 50 and the message is then used to create a calendar record. Subsequently, when the user ventures at or near location Y, his or her location will be detected as a change in the presence attribute being sent to the personal calendar 40 by the management system 10, as illustrated at 60. The presence attribute is enhanced, in accordance with the invention, to include proximity information. This information may be communicated by the user's portable device or by another system associated with the user. In FIG. 2, the user's location is updated by cell phone and also optionally by the car navigation (GPS) system.

The personal calendar application 40 detects when the conditions are met as specified in instant message 50. When the conditions are met (when the person is at or near Y) a reminder message is sent as an instant message 70 to the user, reminding the user to do x when at Y. The instant message is routed to the user's portable device, or any other appropriate device as specified by the user for receiving instant messages.

Adding proximity information to the presence attribute can greatly enhance the usefulness of instant messaging systems and calendar reminder systems. In addition to the use as a personal reminder system, the architecture will also support public reminders. For example, one user may utilize the instant messaging system to send another user a proximity-dependent reminder. The user would, for example, employ a text message such as “remind [recipient] about [topic/task] when [at/near] [location] [next time/repeatedly].” This message can be sent as a text message according to instant messaging protocols, or it may be sent as a multimedia message, such as a voice message which is then forwarded through a multimedia messaging system and parsed into text. If desired, a voice recognition interface may be provided which translates a reminder into a command or message to the reminder management system 10. This would allow a reminder to be created by voice.

In the preceding example, the reminder message was designated for a particular recipient. However, the proximity reminder system of the invention is capable of utilizing proximity data in a more global fashion. A traffic congestion detection system may be implemented using the proximity information supplied through the instant messaging and presence channel. In this scenario, once vehicle occupants have widely adopted instant messaging systems (e.g., cellular phones or navigation systems) those systems may be used to automatically publish their location and presence attributes to a global resource. The global resource then ascertains the location of potential high congestion areas or traffic jams, based on the current number of persons at that location as compared to the expected number of persons. Thus a useful traffic congestion report can be sent as an instant message to vehicle navigation systems or other instant messaging devices. Note that the traffic report information is readily obtained from the location and proximity data that are automatically generated as a consequence of multiple persons using the instant messaging system with the enhanced capabilities of the invention.

In use as a personal reminder system, it bears noting that the reminders need not be precisely temporally constrained, but rather may depend on location or proximity. Conventional calendar reminder systems do not work this way. Thus the reminder system of the invention may be configured to remind a person to do something based on situations such as:
Next time I am at the library, I want to look for book X;
Next time I am at the grocery store I want to buy Y;
Every time I go downtown I need to stop at the bank;
Next time I am at Sue's house I want to ask about Z.

There are a variety of technologies by which a person's geographic position can be determined. Examples include a GPS system in the vehicle the person is driving or riding in, the person's position within a cellular network when the person is using his or her cell phone, the location of the person based on his or her use of a satellite radio, and so forth. When a person's location can be electronically determined, position events can be collected and the reminder management system 10 will determine if any reminder requests need to be responded to. When a reminder is triggered, a message may be sent to the person who sent the reminder (or to some other recipient). The reminder can be in text form or multimedia message form, following whatever pattern was entered to initiate the reminder.

The message can be sent to various devices used by the recipient for receiving messages, and the recipient may have previously specified preferences which be followed. Alternatively, the recipient's presence information may indicate which device is active in locating the recipient, or the location event may indicate which device is active in locating the recipient.

As part of its function in mediating reminder messages, the reminder management system is also preferably configured to furnish an interface through which the user can delete or modify reminders. In one embodiment, the interface is operated using instant messages. Instant messages are sent to the reminder management system and these messages are then parsed according to predefined keywords or patterns of keywords to ascertain that the message is intended as a meta command to delete or modify a message, as opposed to add a new reminder.

Thus the user might send an instant message or multimedia message stating, “delete reminder created yesterday,” or “delete reminder about the library.” Modifying a reminder would be accomplished in a similar fashion, by a delete operation followed by a create operation, or by such commands such as:
For reminder about [topic]
   change recipient to [new-recipient]
   change location to [new-location]
   change position to proximity
   change occurrence to [once/repeatedly]

The reminder management system 10 may be configured to update the calendar at the time the event is accepted as a record of activity. The system will check for conflicting proximity events and for conflicting time events and a suitable instant message can be sent to the user alerting of such conflicts. Alternatively, the system can intelligently decide to temporarily ignore a reminder if that reminder conflicts with a higher priority reminder. For example, a reminder to return a book to the library might be temporarily suspended if the user is late for a doctor's appointment to which he or she is en route.

In a presently preferred embodiment, the reminder management system includes the ability to perform a variety of logical decisions. The system can thus qualify proximity events based on time. If the user is at a certain place within a certain timeframe, a reminder may be sent. If the user is at that location but outside the specified timeframe, a different action can be scheduled, or the reminder can be ignored entirely, based on the preprogrammed wishes of the user. Instant messages may be sent to the user (for reminder purposes) to other persons and also to other software systems. The latter case provides a powerful extension of the reminder system, as it allows instant messages to act as control signals, causing other software applications to perform specified functions. As an example, proximity to an airport might send an instant message to a hotspot availability system that would then notify the user by an instant message over the user's cell phone, for example, that a convenient Wi-Fi (IEEE 802.11 specification) hotspot may be found at a particular location at the airport. Without this instant message being sent, the user might not know that he or she was within a few meters of a convenient hotspot.

The reminder system is also preferably configured to allow the user to exert privacy control over tasks, particularly tasks received from others. Thus the user can elect to block the sending of instant messages based on proximity, if those messages are in response to a reminder task sent from another. This allows the user to keep his or her proximity information secret as to certain third parties, if desired. In addition, the management system also implements security features to allow users to control who has access to the information contained within the user data store 12. These security features thus allow multiple users to use the proximity reminder system, each in a secure way without affecting the use by other users.

The description of the invention is merely exemplary in nature and, thus, variations that do not depart from the gist of the invention are intended to be within the scope of the invention. Such variations are not to be regarded as a departure from the spirit and scope of the invention. Accordingly, while the invention has been described in its presently preferred forms, it will be understood that the invention is capable of modification without departing from the spirit of the invention as set forth in the appended claims.

1. In an instant messaging system, a reminder system comprising:
a reminder management system having a port adapted to communicate using instant messages with an instant messaging service;
a proximity system for ascertaining proximity information associated with a user of the instant messaging system;
a calendar system having a data store for storing reminder information associated with said user, said calendar data store being configured to store proximity information in association with said reminder information;
said calendar system being coupled to said reminder management system and being operative to send instant messages to said user based on the user's associated proximity information as obtained by said proximity system.

2. The system of claim 1 wherein said proximity system uses a geographic information system to ascertain proximity information.

3. The system of claim 1 wherein said proximity system detects event information and uses said detected events to deduce said proximity information.

4. The system of claim 2 wherein said proximity system includes a look up data store for converting geographic coordinate information into proximity information.

5. The system of claim 1 wherein said reminder management system is configured to send instant messages collectively to a plurality of users.

6. The system of claim 1 further comprising speech input system coupled to said reminder management system that converts speech utterances into data used to construct said reminder information.

7. The system of claim 1 wherein said reminder management system is configured to alter a presence attribute associated with said instant messaging service based on said ascertained proximity information.

8. The system of claim 1 further comprising global resource communicating with the reminder management systems of plural users and operative to construct aggregate information from which the degree of congestion within a predefined geographic region may be inferred.

9. The system of claim 1 further comprising user interface to enable said reminder information to be revised based on instant messages supplied through said instant messaging service.

10. The system of claim 1 further comprising user interface to enable said reminder information to be revised based on messages supplied by speech.

11. A method of providing proximity-based reminders, comprising:
populating a data store with reminder information associated with a user;
associating proximity information with said reminder information;
ascertaining current proximity data associated with the user by automated means; and
selectively providing reminders to said user as instant messages through an instant messaging service based on a comparison of the user's current proximity data and said associated proximity information.

12. The method of claim 11 wherein said populating step is performed automatically in response to accepting a record of activity in a calendar system.

13. The method of claim 11 further comprising storing time information in association with said reminder information and checking said associated proximity information to identify reminder information that have conflicting times and proximities.

14. The method of claim 13 further comprising suspending selected reminders when conflicting times and proximities are identified.

15. The method of claim 11 further comprising publishing said ascertained current proximity data using said instant messaging service.

16. The method of claim 15 further comprising selectively inhibiting the publishing of said ascertained current proximity data based on instructions provided by the user.

17. The method of claim 11 further comprising providing said reminders to the user via instant messaging appliances that are selected based on said current proximity data.

18. The method of claim 11 further comprising providing said reminders to the user via instant messaging appliances that are selected based on said associated proximity information.
